(19) United States
(12) Patent Application Publication
(10) Pub. No.: US 2005/0190859 A1
(43) Pub. Date: Sep. 1, 2005

(54) IF derived data slicer reference voltage circuit

(75) Inventor: Richard Paul Brandwein JR., Lisle, IL (US)

Correspondence Address: FOLEY AND LARDNER;SUITE 500, 3000 K STREET NW, WASHINGTON, DC, 20007, US

(73) Assignee: OMRON CORPORATION

(21) Appl. No.: 10/788,420

(22) Filed: Mar. 1, 2004

(51) Int. Cl. H04L 5/12

(52) U.S. Cl. 375/316

(57) ABSTRACT

A method of deriving a reference voltage for a data slicer features supplying a signal to a filter and filtering the signal; supplying the filtered signal to a comparator which comprises the data slicer; passing the signal prior filtering through an RC circuit; and using the output of the RC circuit as the reference voltage for the comparator.

### BACKGROUND OF THE INVENTION

1. Field of the Invention

The present invention relates generally to a receiver circuit for use in devices such as keyless entry arrangement for automotive vehicles and the like, and more specially to a receiver which includes a circuit arrangement that provides a threshold voltage for a data slicer which forms part of the receiver, in a manner which allows the receiver to be produced economically and without sacrificing sensitivity.

2. Description of the Relevant Art

FIG. 1 schematically depicts a prior art circuit arrangement 10 and shows the internal 11 and external stages 12 of a PLL (phase-locked loop) IC. In this figure, the internal stages 11 are shown within the broken line and are sealed within the chip. The circles denote the pins which permit electrical connection between the internal and external stages 11, 12. In this arrangement, the external stage 12 comprises capacitors and resistors which are connected in the illustrated manner.

In the internal stage 11, an op-amp 14 is connected to a ASK/FSK switch 16 and functions as a low-pass data filter for data emitted from the ASK/FSK switch 16 . A comparator 18 is connected to the op-amp 14 and functions as a single bit A/D converter. The external stage 12 is designed to produce a threshold voltage from the filtered data produced by the center op amp 14 using components R and C. This threshold voltage is applied to the comparator 18 which functions as a data slicer.

However, the problem with this approach is that a data stream with a high DC content, is difficult to process when using a data slicer having only a single comparator such as in the case of the FIG. 1 circuit. More specifically, setting an RC time constant on the output of the data filter produces corrupted data bits after a long period of high signal. This causes the capacitor C to charge to peak voltage and induces the drawback that the capacitor will take several bit widths before it discharges to a level of approximately 50% of the faster data rate in the signal stream. Since the data stream does not repeat any information in the signal broadcast, corrupted bits are lost and the data cannot be used. Thresholds derived from a PDO source reduce receiver signal sensitivity excessively.

Other alternative methods of producing a threshold level involve the use of discrete components. However, these drive up the cost of the receiver device.

There is therefore, a need for a circuit arrangement which is capable of dealing with a data stream with a high DC content and which uses a data slicer having only a single comparator.

### SUMMARY OF THE INVENTION

The embodiments of the invention are such as to solve this problem by using data which is tapped off prior to filtering (e.g. prior to low pass filtering in the manner shown in FIG. 3) and using this in lieu of the filtered data which is tapped off after low pass filtering (see FIG. 2) to produce the threshold voltage for the comparator which performs the data slicing.

The use of this data, which contains a component with a higher frequency, provides a much larger number of “edges” in the signal (inasmuch as the overall frequency is higher than that of the filtered data). Accordingly, the duration of the data signal is shorter and the problem wherein the capacitor is induced to charge to peak voltage and thus generates an output which remains erroneously constant for long periods of time, is obviated.

This invention uses an extremely simple circuit arrangement comprising a low cost resistor and capacitor arrangement which, without sacrificing sensitivity, controls the threshold level to 50% regardless of incoming signal strength. A secondary benefit which is possible with given embodiments is that a slight voltage drop across the data filter section created a “quiet” data output when no intentional broadcast is being received.

In a nutshell, the invention uses an RC lowpass filter network from the IF stage of a cascaded RF receiver system to provide a threshold voltage for a data slicer.

An embodiment of the invention resides in an RF receiver that incorporates the above circuitry. In a specific case, the RF receiver is built around a TDA5211 PLL IC which is commercially available from Infineon Technologies AG. The reason for this is that this IC has an internal resistance of 330k which is connected between the output of the ASK/FSK switch (where the data is modulated in the filtered 10.7 MHz carrier frequency) and the inverse comparator input. As such, the simple elimination of a resistor (R) from the external stage is all that is needed to complete the RC threshold network according to the invention.

More specifically, a first aspect of the invention resides in a method of deriving a reference voltage for a data slicer comprising: supplying a signal to a filter and filtering the signal; supplying the filtered signal to a comparator which comprises the data slicer; passing the signal prior filtering through an RC circuit; and using the output of the RC circuit as the reference voltage for the comparator.

In this method the filter is a low pass filter, and the data slicer forms part of a cascaded RF receiver system. The signal is an IF (Intermediate Frequency) signal and the frequency of the signal is in the range of about 80 KHz to about 15 MHz.

In accordance with this aspect of the invention amplifying the signal can be carried out before the step of filtering the signal. Further, it is possible to adjust the value of a capacitor comprising the RC circuit. Alternatively, or in addition to the adjustment of the capacitor, it is possible to adjust the value of a resistor of the RC circuit

A second aspect of the invention resides in a method of obviating a DC offset from an amplified modulated IF data signal, comprising: supplying the modulated IF signal to a first filter circuit and a second filter circuit; supplying a first filtered signal from the first filter to a comparator as a data signal; and supplying a second filtered signal from the second filter to the comparator as a reference voltage for the comparator.

In accordance with this aspect of the invention, the modulated IF signal is an amplified IF signal. The second filter is a low pass filter comprising an RC circuit.

A further aspect of the invention resides in a circuit comprising: a source of an IF frequency signal for demodulation; a filter and a comparator serially connected with the source; and a reference voltage circuit connected to the comparator and configured to produce a comparator reference voltage, the reference voltage circuit comprising a resistor and a capacitor, the resistor being connected to a point between the source and the filter so as to be responsive a signal which is being supplied to the filter.

In accordance with this aspect of the invention, the source of the IF frequency signal comprises an ASK/FSK switch. The source of an IF frequency signal, filter and comparator which are serially connected with the source, comprise elements of an internal stage of a chip.

Another aspect of the invention resides in a circuit comprising: a source of an IF frequency signal for demodulation; a filter and a comparator serially connected with the source; and a reference voltage circuit connected to the comparator and configured to respond to a signal having a component which is comparable with a component filtered by the filter.

In accordance with this aspect of the invention the circuit forms part of a wireless communication device such as a keyless entry system or a tire pressure monitoring system for an automotive vehicle.

### BRIEF DESCRIPTION OF THE DRAWINGS

The various features and advantages of the embodiments of the invention will become more clearly appreciated as a detailed description of the preferred embodiments is given with reference to the appended drawings wherein:

FIG. 1 is an example of a circuit arrangement according to the prior art wherein the slicer reference voltage is derived on the basis of data which has been subjected to low pass filtering;

FIGS. 2 and 3 are conceptual depictions comparing the manner in which data is tapped for the purposes of adjusting the data slicer reference voltage by the above discussed prior art and the embodiments of the invention, respectively;

FIG. 4 is a schematic depiction showing the manner in which a simple RC circuit is used to develop a voltage suitable for controlling a data slicer which uses only a single comparator;

FIG. 5 is a circuit diagram showing an embodiment of the invention which is fundamentally similar to the prior art of FIG. 1 but wherein data, which is tapped off prior being filtered, is used in combination with a simple RC circuit to derive the reference voltage which is used by the data slicer;

FIG. 6 is a circuit diagram showing a further embodiment of the invention wherein a greater degree of design freedom is provided by arranging for resistors which are otherwise fixed, to be replaced components having different values.

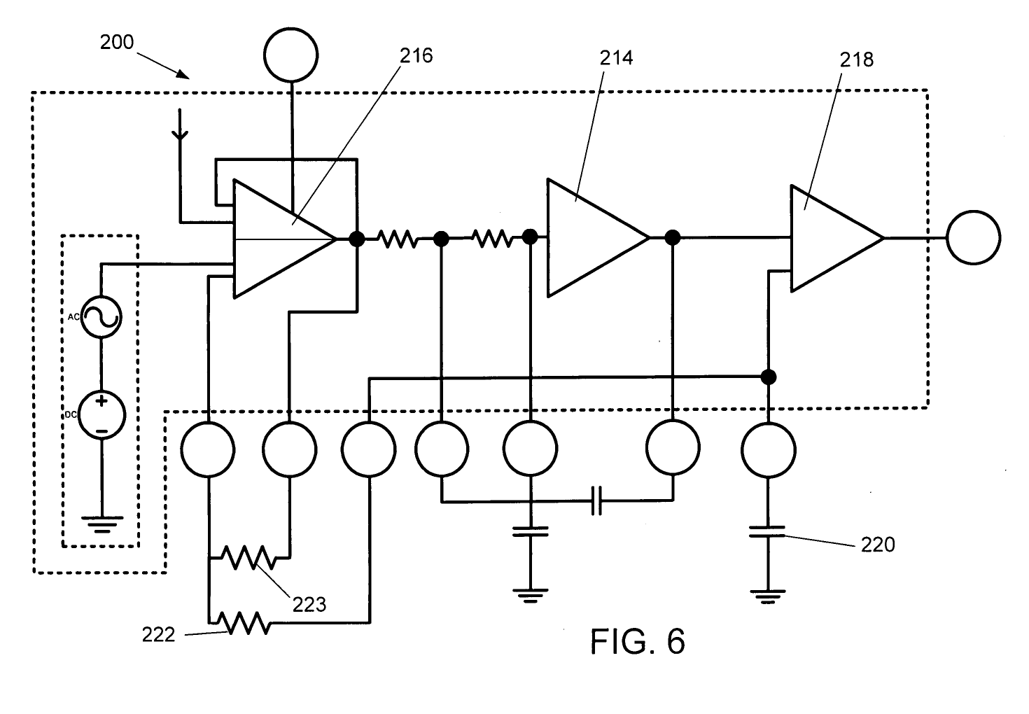

### DETAILED DESCRIPTION OF THE EXEMPLARY EMBODIMENTS

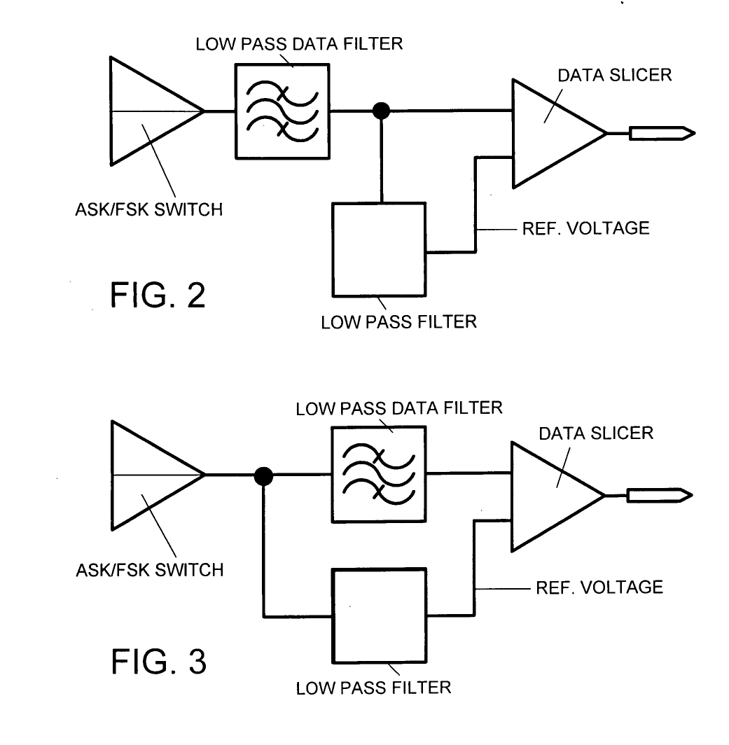

As noted above, FIGS. 2 and 3 compare the prior art with the arrangement which exemplifies the present invention. The use of the higher frequency data signal which is tapped off upstream of the low pass filter which is interposed between the ASK/FSK switch and the comparator that functions as the single bit A/D converter.

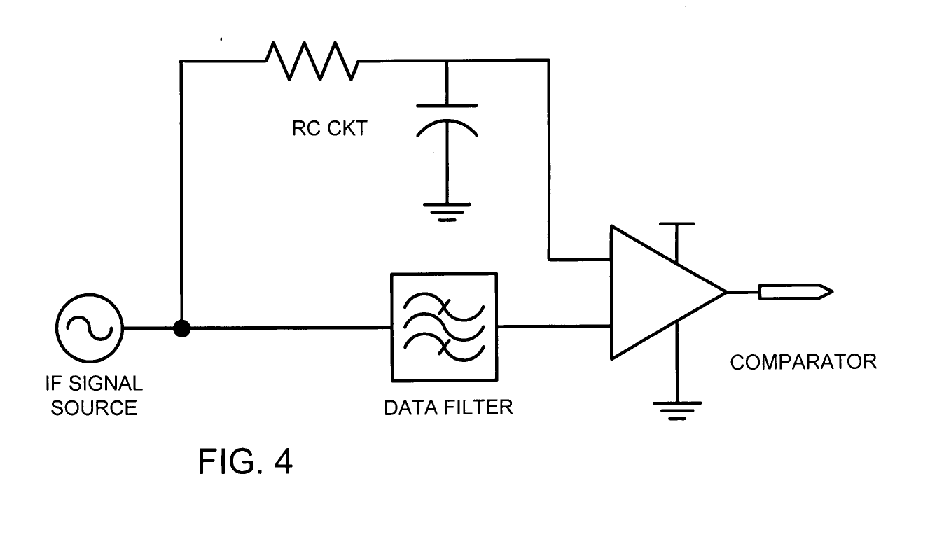

FIG. 4 depicts the arrangement wherein the low pass filter which is shown in FIG. 3 and which is used to develop the reference voltage which is used in the comparator to provide the data slice function, comprises a simple RC circuit.

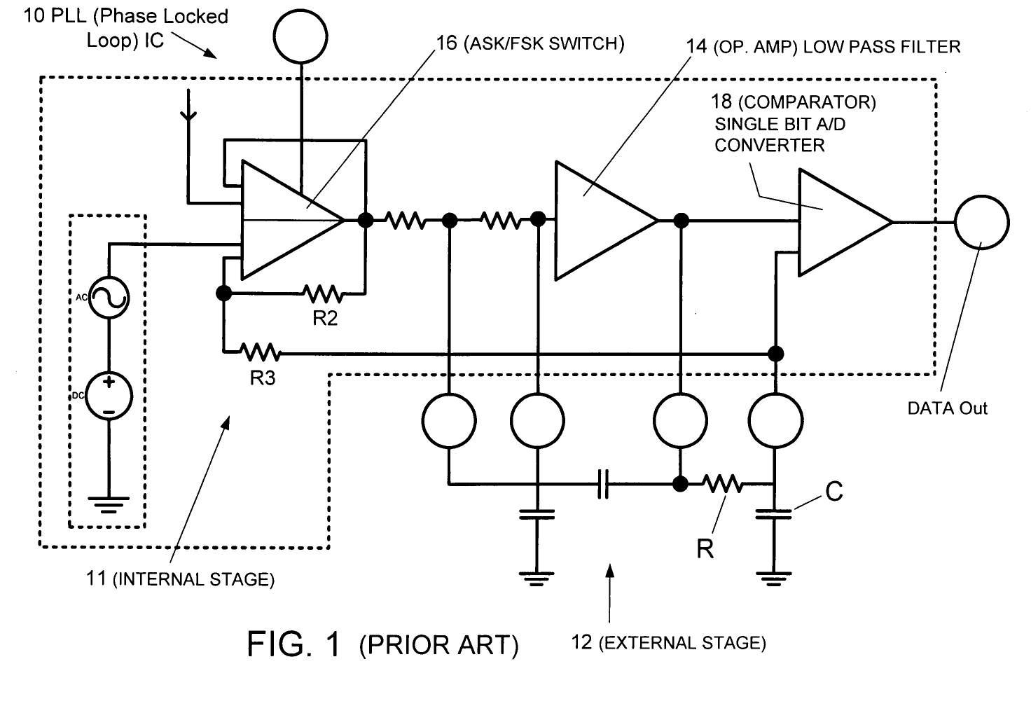

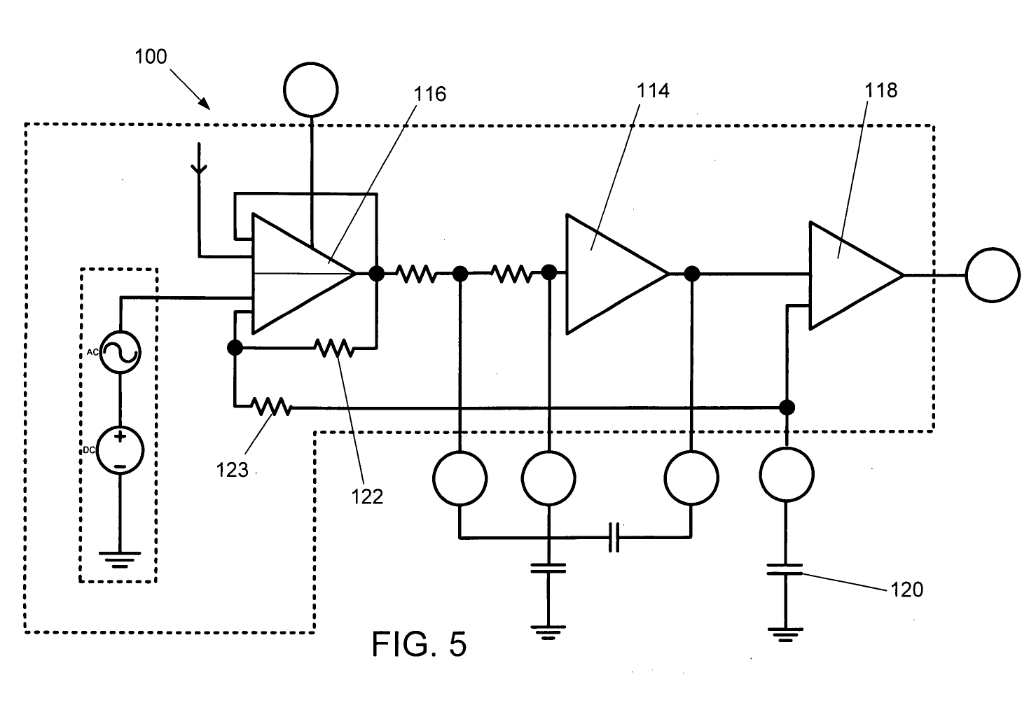

FIG. 5 shows a circuit arrangement which has been adapted via a simplification of the prior art shown in FIG. 1, to change from the configuration depicted in FIG. 2 to that which is depicted in FIG. 3. This transformation is achieved by removing the resistor designated R from the external stage and making use of the resistors R2 and R3 which are associated with the ASK/FSK switch. This established an RC circuit wherein the resistor is comprised of R2+R3 and wherein the capacitor remains as the same as C denoted in FIG. 1.

In FIG. 5, the resistors R2, R3 are denoted by the numerals 122 and 123 respectively. Capacitor C is denoted by 120 while the ASK/FSK switch, operational amp and comparator are respectively denoted by the numerals 116, 114 and 118. The overall circuit is designated by the numeral 100.

As will be appreciated, the fact that resistors 112 and 123 form part of the internal stage and are sealed within the chip, they are not replaceable/adjustable in the same manner as the capacitor 120. Accordingly, in a further embodiment of the invention a modified chip is used and the resistors 112 and 123 are replaced by resistors 212 and 213 that are incorporated into the external stage via the provision of additional pins.

With this embodiment, the resistors 212 and 213 are rendered replaceable/adjustable along with the capacitor 220 and the circuit is not limited to a resistance in the RC circuit which is the sum of the resistances of resistors 122 and 123. This embodiment alleviates the problem wherein the circuit tends to be limited with respect to incoming signals that have frequencies outside of the range which can be dealt with the circuit arrangement wherein R is fixed and only the value of C is variable.

For example, assume that the resistances of 122 and 123 are respectively 300Ω and 30Ω then the embodiment which is depicted in FIG. 5 would tend to be limited to signals up to about DC 4 KHz MHz. However, with the ability to adjust the values of the resistors 122 and 123 along with capacitor 120 a greater range of signal process is rendered possible.

It will be appreciated that, while the resistors 212 and 213 and the capacitor 220 are illustrated as fixed value components which can be changed out for ones with different resistances and capacitances, these components can, if so desired, be replaced with variable resistance and capacitance arrangements to allow for “on the fly” tuning of the circuit.

Applications of the invention can be found in any ASK RF receiver where the data stream has a high DC component and where the IF stage can be accessed before the signal is goes into the data filter and data slicer stages.

The embodiments of the invention find advantageous application in automotive remote keyless entry and tire pressure monitoring systems. However, the invention can, of course be used for any digital signal demodulation scheme that utilizes a comparator for data slicing.

Although the invention has been disclosed with reference to only a limited number of embodiments, the various modifications and changes that can be made without departing form the scope of the invention, which is limited only by the appended claims, will be self-evident to a person of skill in the art or that which most closely related to the invention, given the preceding disclosure.

For example, the circuit shown in FIG. 1 could be forced to operate in accordance with the invention if the value of R (external stage) was elevated to the degree that it was effectively removed from the circuit. Indeed, by rendering the resistance R variable between a normal value and an extremely high one, it could be possible to switch the circuit back and forth between the arrangements shown in FIGS. 2 and 3. Alternatively, a transistor could be circuited in series with the resistance R and selectively rendered conductive/non conductive so as to establish/cut off the electrical connection between R and C and thus switch between the arrangements depicted schematically in FIGS. 2 and 3.

1. A method of deriving a reference voltage for a data slicer comprising:
supplying a signal to a filter and filtering the signal;
supplying the filtered signal to a comparator which comprises the data slicer;
passing the signal prior filtering through an RC circuit; and
using the output of the RC circuit as the reference voltage for the comparator.

2. A method as set forth in claim 1, wherein the filter is a low pass filter.

3. A method as set forth in claim 1, wherein the data slicer forms part of a cascaded RF receiver system.

4. A method as set forth in claim 1, wherein the signal is an IF (Intermediate Frequency) signal.

5. A method as set forth in claim 3, wherein the frequency of the signal is up to about 4 KHz.

6. A method as set forth in claim 1, further comprising amplifying the signal before the step of filtering the signal.

7. A method as set forth in claim 1, further comprising adjusting a value of a capacitor comprising the RC circuit

8. A method as set forth in claim 1, further comprising adjusting a value of a resistor of the RC circuit

9. A method as set forth in claim 1, further comprising adjusting values of at least one of a resistor and a capacitor of the RC circuit in order to modulate the reference voltage supplied to the comparator.

10. A method of obviating a DC offset from an amplified modulated IF data signal, comprising:
supplying the modulated IF signal to a first filter circuit and a second filter circuit;
supplying a first filtered signal from the first filter to a comparator as a data signal; and
supplying a second filtered signal from the second filter to the comparator as a reference voltage for the comparator.

11. A method as set forth in claim 10, wherein the modulated IF signal is an amplified IF signal.

12. A method as set forth in claim 10, wherein the second filter is a low pass filter.

13. A method as set forth in claim 12, wherein the second low pass filter is an RC circuit.

14. A circuit comprising:
a source of an IF frequency signal for demodulation;
a filter and a comparator serially connected with the source; and
a reference voltage circuit connected to the comparator and configured to produce a comparator reference voltage, the reference voltage circuit comprising a resistor and a capacitor, the resistor being connected to a point between the source and the filter so as to be responsive a signal which is being supplied to the filter.

15. A circuit as set forth in claim 14, wherein the source of the IF frequency signal comprises an ASK/FSK switch.

16. A circuit as set forth in claim 14, wherein the source of an IF frequency signal, filter and comparator serially connected with the source, comprise elements of an internal stage of a chip.

17. A circuit as set forth in claim 16, wherein the resistor of the reference voltage circuit is an internal element of the chip.

18. A circuit as set forth in claim 16, wherein the capacitor of the reference voltage circuit comprises part of an external stage of the chip.

19. A circuit as set forth in claim 16, wherein the resistance and the capacitor of the reference voltage circuit comprise parts of the an external stage of the chip.

20. A circuit comprising:
a source of an IF frequency signal for demodulation;
a filter and a comparator serially connected with the source; and
a reference voltage circuit connected to the comparator and configured to respond to a signal having a component which is comparable with a component filtered by the filter.

21. A circuit as set forth in claim 20, wherein the circuit forms part of a wireless communication device.

22. A circuit as set forth in claim 21, wherein the wireless communication device comprises a keyless entry system for an automotive vehicle.

23. A circuit as set forth in claim 21, wherein the wireless communication device comprises a tire pressure monitoring system for an automotive vehicle.
